(19) United States
(12) Patent Application Publication
(10) Pub. No.: US 2006/0218848 A1
(43) Pub. Date: Oct. 5, 2006

(54) Scent releasing/absorbing system for an in-line, rotating fishing chum and/or fishing scent dispenser

(76) Inventors: Terry Melhorn, Dallastown, PA (US); Jessica Melhorn, Lansdale, PA (US)

Correspondence Address: Terry Melhorn, P.O. Box 31, Dallastown, PA, 17313, US

(21) Appl. No.: 11/390,640

(22) Filed: Mar. 28, 2006

Related U.S. Application Data
(60) Provisional application No. 60/666,233, filed on Mar. 29, 2005.

(51) Int. Cl. A01K 97/02; A01K 85/01

(52) U.S. Cl. 43/44.99; 43/42.06

(57) ABSTRACT

A technique for releasing and/or absorbing-releasing scent, for an in-line, rotating fishing chum or fishing scent dispenser, the dispenser typically having front and rear fins is described. The technique enables the scent to be rapidly distributed to more readily attract fish, to the close proximity of the fisherman, and specifically to the baited hooks or the lure being used by the fisherman.

### CROSS-REFERENCE TO RELATED APPLICATIONS

The present Utility patent application claims priority benefit of the U.S. provisional application for patent No. 60/666,233 filed on Mar. 29, 2005 under 35 U.S.C. 119(e) and U.S. patent application Ser. No. 11/347,592 filed on Feb. 4, 2006. The contents of these related applications are incorporated herein by reference.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates to fishing bait distributors or chumming devices. More particularly, the present invention relates to scent releasing and/or scent absorbing-releasing forms or devices to be used in an in-line, rotating fishing chum and/or fishing scent dispenser device to distribute scent into water, to attract fish to the close proximity of the fisherman and specifically to baited hooks or to the lure being used by the fisherman.

### BACKGROUND TO THE INVENTION

Recreational or sport fishing has constantly increased in popularity. What once was just a summertime hobby has become a yearlong activity for tens of millions worldwide. Many fishermen choose to engage in a very leisurely type of fishing that involves casting a fishing line, connected to baited hook(s) and a sinker-type device, into the water, to sit at a certain spot, while hoping to attract fish near that spot, through visual contact with the bait, or by the fish being attracted to the scent of the bait. Still other fishermen may use lures containing small amounts of scent or chum, or lures and bait, to attract fish to their hooks. The practice of chumming involves the introduction of large amounts of scented solid, particulate or liquid matter, into the water, in hopes that the solids, particulate or the particular scent of the chum, or the combination of all three, will be attractive to many fish, that the fisherman is attempting to catch. Chumming has mostly been practiced from boats, with several fishermen on board, and with those fishermen tossing their baited hooks into the created chum slick, to attempt to catch fish attracted by the chum material and the fish-attracting scent. Chumming is a time proven method of attracting fish, from a wide area of water, to the baited hooks or lures of the fishermen, to be caught by those fishermen.

However, the small pieces of bait that the individual fishermen generally uses, have limited scent-dispensing ability, and that limited ability rapidly weakens, the longer the bait is in the water. This fisherman may only attract fish from a very small area of water or may attract no fish at all. And, large scale chumming has never been a practical or economical answer for the individual fisherman. Also, many fish scent or chum-dispensing devices are too large and clumsy for the individual fisherman to use. However, an in-line, rotating fishing chum and/or fishing scent dispenser, said dispenser typically having front and rear fins, is small enough and economical enough, for the individual fisherman to use, can be re-freshened with scent, as necessary, and optimizes scent dispersion by it's spinning motion, and will quickly and widely dispense fishing chum and/or fish-attracting scent. The faster fish-attracting scent is introduced to a wide area, the sooner the fish may be attracted and caught by the fisherman. It is generally important to be able to timely fill or refill the in-line, rotating fishing chum and/or fishing scent dispenser, said dispenser typically having front and rear fins, to keep the device in the water as much as possible, dispensing fish-attracting scent, to continue to attract more fish, to be caught by the fisherman.

In view of the foregoing, there is a need for scent releasing and/or scent absorbing-releasing forms or devices that allow the individual fisherman to quickly, initially fill, and rapidly replace or refill the fish-attracting scent or chum, into the in-line, rotating fishing chum and/or fishing scent dispenser, said dispenser typically having front and rear fins.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a perspective view of exemplary scent releasing and/or scent absorbing-releasing forms, in accordance with an embodiment of the present invention;

FIG. 2 is a perspective view of the exemplary scent releasing and/or scent absorbing-releasing forms, shown in FIG. 1, located inside the main holding chamber of an exemplary in-line, rotating fishing chum and/or fishing scent dispenser, in accordance with an embodiment of the present invention;

FIG. 3 is a perspective view of the exemplary scent releasing and/or scent absorbing-releasing forms, shown in FIG. 1 and FIG. 2, inside the main holding chamber of the exemplary in-line, rotating fishing chum and/or fishing scent dispenser, shown in FIG. 2, with the loading door closed, in accordance with an embodiment of the present invention;

FIG. 4 is a perspective view of exemplary scent releasing and/or scent absorbing-releasing forms, as shown in FIG. 1, FIG. 2 and FIG. 3, inside the main holding chamber of an in-line, rotating chum fishing and/or fishing scent dispenser, as shown in FIG. 2 and FIG. 3, as scent material is added to the scent releasing and/or scent absorbing-releasing forms, in accordance with an embodiment of the present invention.

Unless otherwise indicated illustrations in the figures are not necessarily drawn to scale.

### SUMMARY OF THE INVENTION

To achieve the forgoing and other objects and in accordance with the purpose of the invention, a variety of devices for scent releasing and/or scent absorbing-releasing, in an in-line fishing chum and/or fishing scent dispenser, said dispenser optionally having front and rear fins, are described.

A technique for releasing and/or absorbing-releasing scent, for an inline, rotating fishing chum and/or fishing scent dispenser, said dispenser optionally having front and rear fins, is described. The technique enables the scent to be rapidly distributed to more readily attract fish, to the close proximity of the fisherman, and specifically to the baited hooks or the lure being used by the fisherman.

It is an aspect of the present invention to produce or use scent releasing and/or scent absorbing-releasing forms or devices, natural or man-made, to be used specifically in an in-line, rotating fishing chum and/or fishing scent dispenser, said optionally dispenser having front and rear fins, to rapidly distribute scent that attracts fish, to the close proximity of the fisherman, and specifically to the baited hooks or the lure being used by the fisherman.

It is another aspect of the present invention to provide scent releasing and/or scent absorbing-releasing forms or devices, natural or man-made, to be used specifically in an in-line, rotating fishing chum and/or fishing scent dispenser, said dispenser optionally having front and rear fins, that will allow a fisherman to rapidly fill, replace or refill the fish attracting scent or chum, into the holding compartment, of an in-line, rotating fishing chum and/or fishing scent dispenser, said dispenser optionally having front and rear fins

It is yet another aspect of the present invention to provide scent releasing and/or scent absorbing-releasing forms or devices, natural or man-made, to be used specifically in an in-line, rotating fishing chum and/or fishing scent dispenser, said dispenser optionally having front and rear fins, that will allow for rapid and repeated scent dispersal, as the natural forces of water reacts with the scent releasing and/or scent absorbing-releasing forms, natural or man-made, which will decrease the time needed to achieve scent dispersal and increase the width of the area of fish scent dispersal, as water flows in to and out of an in-line, rotating fishing chum and/or fishing scent dispenser, said dispenser optionally having front and rear fins. The natural forces of water may react upon the scent releasing and/or scent absorbing-releasing forms, natural or man-made, for example, without limitation, by way of centrifugal forces, (as the in-line, rotating fishing chum and/or fishing scent dispenser, said optionally dispenser having front and rear fins, spins), pressure differentials (between inside and outside the main holding chamber of the in-line, rotating fishing chum and/or fishing scent dispenser, said dispenser optionally having front and rear fins), by diffusion (as the water reacts to dissolve the chum, chum particles and/or scent dispersing forms, shapes, mechanisms or devices) and by the natural forces of water (currents, waves, etc.), or by any combination of the above.

It is still another aspect of the present invention to provide scent releasing and/or scent absorbing-releasing forms or devices, natural or man-made, to be used specifically in an in-line, rotating fishing chum and/or fishing scent dispenser, said dispenser optionally having front and rear fins, that may absorb and release fish-attracting oils or liquid fishing-attracting scents, into the water, to attract fish to the close proximity of the fisherman, and specifically to the baited hooks or the lure being used by the fisherman.

It is yet still another aspect of the present invention to provide scent releasing and/or scent absorbing-releasing forms or devices, natural or man-made, to be used specifically in an in-line, rotating fishing chum and/or fishing scent dispenser, said dispenser optionally having front and rear fins, that may be of any form or shape or size or constitution. This will include, but is not limited to, all previously known scent releasing forms or mechanisms, natural or man-made, such as, but not limited to, any flaked, particulate, formed or pellet-shaped chum, salmon eggs, corn, scent releasing baits of natural or man-made constitution, foam, cotton, felt, etc., or any and all materials that have great scent absorbing/dispensing qualities, in any shape, size or form, for the purpose of dispensing chum, chum particles and/or scent into the water, and to be used specifically in an in-line, rotating fishing chum and/or fishing scent dispenser, said dispenser optionally having front and rear fins, for the purpose of attracting fish to the close proximity of the fisherman and specifically to baited hooks or to the lure being used by the fisherman.

It is yet still an additional aspect of the present invention to provide scent releasing and/or scent absorbing-releasing forms or devices, natural or man-made, to be used specifically in an in-line, rotating fishing chum and/or fishing scent dispenser, said dispenser optionally having front and rear fins, that will allow scent releasing and/or scent absorbing-releasing forms or devices of varied or different sizes, shapes and constitutions, natural or man-made, to be used together, in a combined fashion, to create both an immediate fish-attracting scent release, that may be achieved with scent absorbing-releasing forms or devices that absorb fish-attracting oils or scents, and to create a longer lasting fish-attracting scent release, using slower to dissolve chum forms or devices, natural or man-made, to be used specifically in the main scent holding compartment, of an in-line, rotating fishing chum and/or fishing scent dispenser, said dispenser optionally having front and rear fins.

A system, composition and method embodiments that implement some or all of the above aspects, is also provided.

Other features, advantages and objects of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

The present invention will now be described in detail with reference to embodiments thereof as illustrated in the accompanying drawings.

Detailed descriptions of the preferred embodiments are provided herein. It is to be understood, however, that the present invention may be embodied in various forms. Therfore, specific details disclosed herein are not to be interpreted as limiting, but rather as a basis for the claims and as a representative basis for teaching one skilled in the art to employ the present invention in virtually any appropriately detailed system, structure or manner. That is, there are numerous modifications and variations of the invention that are too numerous to be listed but that all fit within the scope of the invention. Also, singular words should be read as plural and vice versa and masculine as feminine and vice versa, where appropriate, and alternatives embodiments do not necessarily imply that the two are mutually exclusive.

It is to be understood that any exact measurements/dimensions or shapes or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

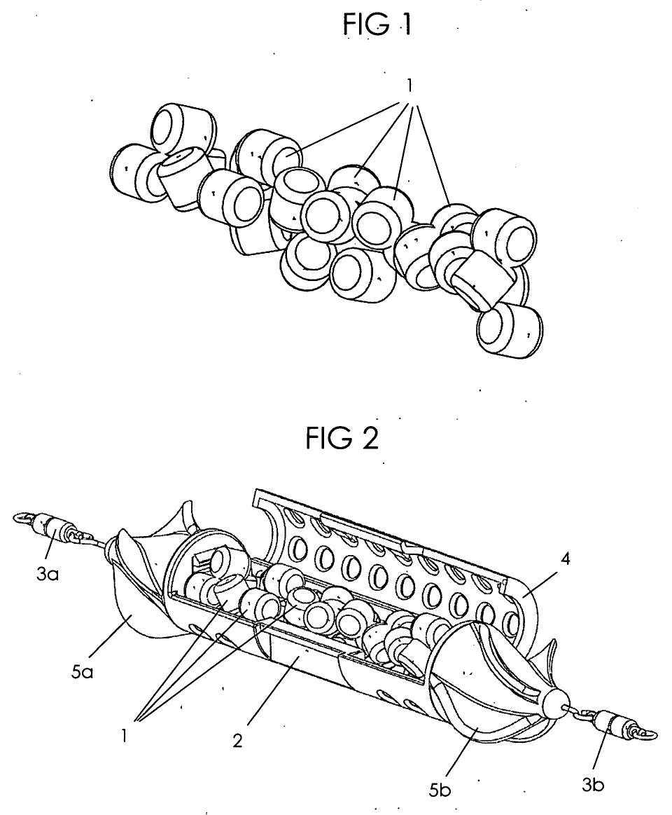

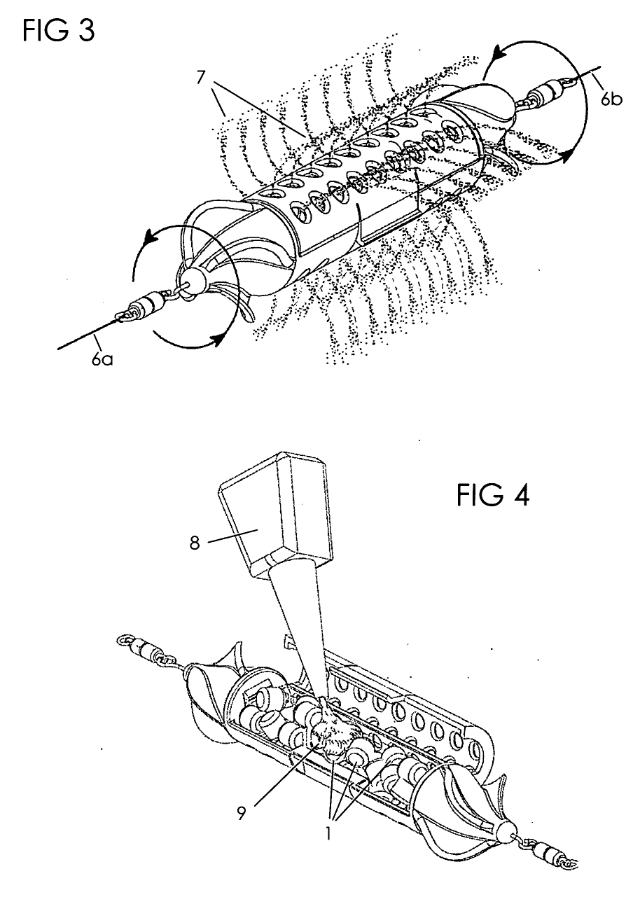

FIG. 1 is a perspective view of exemplary scent releasing and/or scent absorbing-releasing forms 1, in accordance with an embodiment of the present invention. The present embodiment is shown in an orientation that exposes an example form of scent releasing and/or scent absorbing-releasing forms 1, however, those skilled in the art, in light of the present teachings, will recognize that there are many possible alternatives or equivalents of the form, size, shape or constitution of all the many possible shapes, forms, mechanisms and/or materials that may be used as fishing chum and/or fishing/scent releasing and/or scent absorbing-releasing forms or devices. Alternate embodiments may include, without limitation, a single cylindrical shaped form, spherical forms, cube or rectangular forms, oblong forms etc. Examples of possible materials that scent releasing and/or scent absorbing-releasing forms 1 may be constructed of include, without limitation, scent absorbing materials such as, but not limited to foams, cotton or felt or any other cloth materials, plastics, or solid chum or scent materials, scent-impregnated paper products, gelatinous forms, meat or meat products. The present embodiment is used inside the main holding chamber an in-line, rotating fishing chum and/or fishing scent dispenser, said dispenser optionally having front and rear fins, shown in FIG. 2, FIG. 3 and FIG. 4, for the purpose of releasing fish-attracting chum particles and/or scent, into the water for the purpose of attracting fish to the close proximity of the fisherman and specifically to baited hooks or to the lure being used by the fisherman.

In some embodiments scent releasing and/or absorbing-releasing forms 1 may be attached to each other through means such as, but not limited to, adhesives or threads to create one form that may be inserted or taken out of the in-line, rotating fishing chum and/or fishing scent dispenser, said dispenser optionally having front and rear fins, as one piece. In other embodiments the forms may be separate from each other so that they can be placed one by one or poured into the main body of the in-line, rotating fishing chum and/or fishing scent dispenser, said dispenser optionally having front and rear fins, until the main body is full of scent releasing and/or scent absorbing-releasing forms 1.

FIG. 2 is a perspective view of exemplary scent releasing and/or scent absorbing-releasing forms 1, shown in FIG. 1, located inside the main holding chamber of an exemplary in-line, rotating fishing chum and/or fishing scent dispenser, said dispenser optionally having front and rear fins, in accordance with an embodiment of the present invention. In the present embodiment, the in-line, rotating fishing chum and/or fishing scent dispenser 2, said dispenser optionally having front and rear fins comprises a loading door 4 into which scent releasing and/or scent absorbing-releasing forms 1 are inserted. Finned heads 5a and 5b of in-line, rotating fishing chum and/or fishing scent dispenser 2 interact with the natural forces of the water to cause a spinning motion that aids in the rapid broadcasting of the chum particles and/or scent, from scent releasing and/or scent absorbing-releasing forms 1. Swivel-type devices 3a and 3b allow the spinning motion of in-line, rotating chum and/or scent dispenser 2, said dispenser optionally having front and rear fins, which accelerates the broadcasting, of the chum and/or scent, without twisting the fishing line.

FIG. 3 is a perspective view of exemplary scent releasing and/or scent absorbing-releasing forms 1, shown in FIG. 1 and FIG. 2, inside the main holding chamber, of exemplary in-line, rotating fishing chum and/or fishing scent dispenser 2, said dispenser optionally having front and rear fins, shown in FIG. 2, with loading door 4 closed, in accordance with an embodiment of the present invention. In-line, rotating fishing chum and/or fishing scent dispenser 2, said dispenser optionally having front and rear fins is connected, in-line, to fishing lines 6a and 6b in a position where the rotating motion of in-line, rotating chum fishing and/or fishing scent dispenser 2, said dispenser optionally having front and rear fins quickly distributes chum particles and/or scent, from scent releasing and or scent absorbing-releasing forms 1. As the in-line, rotating fishing chum and/or fishing scent dispenser 2, said dispenser optionally having front and rear fins spins, large areas of scent are created to quickly attract fish to the close proximity of the fisherman and specifically to baited hooks or to the lure being used by the fisherman. The scent area can be created by different methods. Non-limiting examples of scent creating methods are as follows, scent releasing and/or scent absorbing-releasing forms 1 may dissolve into the water, water pressure differentials may force the scent out of scent releasing and/or scent absorbing-releasing forms 1, diffusion may cause the release of the scent into the water, the natural forces of water such as, but not limited to, waves, water currents, etc. may force the scent out of scent releasing and/or scent absorbing-releasing forms 1, or any combination of these actions.

FIG. 4 is a perspective view of exemplary scent releasing and/or scent absorbing-releasing forms 1, as shown in FIG. 1, FIG. 2, and FIG. 3, inside the main holding chamber of in-line, rotating fishing chum and/or fishing scent dispenser 2, said dispenser optionally having front and rear fins, as shown in FIG. 2 and FIG. 3, as scent material 9 is added to scent releasing and/or scent absorbing-releasing forms 1, in accordance with an embodiment of the present invention. In the present embodiment, scent material 9 is applied to scent releasing and/or scent absorbing-releasing forms 1 with an applicator bottle 8. In the present embodiment, scent material 9 on scent releasing and/or scent absorbing-releasing forms 1 can be refreshed by applying more scent material 9 onto scent releasing and/or scent absorbing-releasing forms 1 with applicator bottle 8 through loading door 4 of in-line, rotating fishing chum and/or fishing scent dispenser 2, said dispenser optionally having front and rear fins. Also, the scent-refreshing process, can easily and quickly be performed by the fisherman as often as needed, to ensure that enough chum and/or scent is being released into the water, to continually attract the fish. Those skilled in the art will recognize, in light of the present teachings, that there are many suitable materials possible for scent material such as, but not limited to, fish oils or any other fish-attracting oils, particulates or substances, fish eggs, corn, meats, blood substances, commercially manufactured scent substances, natural baits or substances. In the present embodiment scent material 9 is a liquid or oil type scent material that is added to scent releasing and/or scent absorbing-releasing forms 1 as a possible way of attracting fish through the use of in-line, rotating fishing chum and/or fishing scent dispenser, said dispenser optionally having front and rear fins 2. When an in-line, rotating fishing chum and/or fishing scent dispenser 2, said dispenser optionally having front and rear fins is in use, in the water, liquid or oil scent material 9 is broadcast into the water through one of the scent dispersal methods described previously.

In alternate embodiments scent material 9 may be applied to other shapes, mechanisms or devices. Scent releasing and/or scent absorbing-releasing forms to be used specifically in in-line, rotating fishing chum and/or fishing scent dispenser 2, said dispenser optionally having front and rear fins and as shown in FIG. 1, FIG. 2, FIG. 3 and FIG. 4, according to the present invention include, without limitation, any form, shape, type of mechanism or material, man made or of natural materials, that can be used inside of in-line, rotating fishing chum and/or fishing scent dispenser 2, said dispenser optionally having front and rear fins for the purpose of dispensing chum, chum particles, scents, oils or any other fish attracting materials into the water to aid fishermen in catching fish. Some examples of alternate embodiments are, without limitation, material that is capable of absorbing and releasing scent material such as but not limited to foam, cotton, felt or wool that is formed into a specific shape and size to fit into in-line, rotating fishing chum and/or fishing scent dispenser 2, said dispenser optionally having front and rear fins, unformed absorbing-releasing material that can be packed into the main cavity of in-line, rotating fishing chum and/or fishing scent dispenser 2, said dispenser optionally having front and rear fins, or multiple, small scent absorbing-releasing forms made of absorbing-releasing material that can be inserted into the main cavity of in-line, rotating fishing chum and/or fishing scent dispenser 2, said dispenser optionally having front and rear fins until the main cavity is full of the small forms.

In some embodiments the scent releasing and/or scent absorbing-releasing forms to be used specifically in in-line, rotating fishing chum and/or fishing scent dispenser 2, said dispenser optionally having front and rear fins may be solid scent material including, without limitation, any flaked, formed or pellet-shaped chum of man made or natural materials that will dissolve in the water, thus releasing the scent and attracting fish. In an alternate embodiment the scent releasing and/or scent absorbing-releasing forms may be a type of capsule containing chum or scent material. In this embodiment the outer shell of the capsule would be made of a material that would dissolve in the water thus releasing the chum or scent material into the water as the capsules dissolved. In the two previous embodiments, when the scent releasing forms become ineffective or dissolves, the fisherman opens loading door 4 of in-line, rotating fishing chum and/or fishing scent dispenser 2, said dispenser optionally having front and rear fins, may remove what is left of the scent releasing and/or scent absorbing-releasing forms, and inserts new scent releasing and/or scent absorbing-releasing forms may be scent dispensing products or scent absorbing/dispensing products made of man made or of natural materials including, without limitation, foam, cotton, felt, or any other material that has absorbing/dispensing qualities, that would absorb fish oils, other oils, or any other absorbable scent material. Scent releasing and/or scent absorbing-releasing forms 1 may be any shape, size or form, that will fit into in-line, rotating fishing chum and/or fishing scent dispenser 2, said dispenser optionally having front and rear fins for the purpose of dispensing fishing chum, chum particles and/or fish-attracting scent into the water.

When in use, scent releasing and/or scent absorbing-releasing forms 1 to be used specifically in in-line, rotating fishing chum and/or fishing scent dispenser 2, said dispenser optionally having front and rear fins will quickly broadcast fish-attracting chum, chum particles and/or scent into the water by way of centrifugal forces as in-line, rotating fishing chum and/or fishing scent dispenser 2, said dispenser optionally having front and rear fins spins, pressure differentials between inside and outside the main holding chamber of in-line, rotating fishing chum and/or fishing scent dispenser, said dispenser optionally having front and rear fins, by diffusion as the water reacts to dissolve the scent material, by the natural forces of water such as, but not limited to, currents, waves, etc., or by any combination of the above forces, as shown in FIG. 3.

Having fully described at least one embodiment of the present invention, other equivalent or alternative scent releasing and/or scent absorbing-releasing forms or devices for use in an in-lime rotating fishing chum and/or fishing scent dispenser, said dispenser optionally having front and rear fins, according to the present invention, will be apparent to those skilled in the art. For example, although the foregoing embodiments shown were described in the context of a particular in-line, rotating fishing chum and/or fishing scent dispenser example, those skilled in the art will readily recognize a multiplicity of alternative and suitable in-line, rotating fishing chum or fishing scent dispensers, which are all considered to be within the spirit of the present invention. By way of example, and not limitation, instead of directly place a scent releasing form into the main holding chamber, in some alternative embodiments, a small container (e.g., without limitation, made of plastic), with a multiplicity of holes in it is configured to be small enough to fit in the holding chamber of the in-line, rotating fishing chum and/or fishing scent dispenser, said dispenser optionally having front and rear fins, whereby that container is first filled with a scent releasing material, and then placed inside the holding chamber of the in-line, rotating fishing chum and/or fishing scent dispenser, said dispenser optionally having front and rear fins. Moreover, the forms of the present invention have been described above by way of illustration, and the specific embodiments disclosed are not intended to limit the invention to the particular forms disclosed. The invention is thus to cover all modifications, equivalents, and alternatives falling within the spirit and scope of the following claims.

What is claimed is:

1. A system for scent releasing and/or scent absorbing-releasing, in combination with an in-line, rotating fishing chum and/or fishing scent dispenser, the system comprising:
a scent releasing and/or scent absorbing-releasing form that is operable for absorbing and releasing a scent producing material, said scent releasing and/or scent absorbing-releasing form being suitable to be placed inside a holding compartment of the in-line, rotating fishing chum and/or fishing scent dispenser; and
means for releasing the scent stored in said scent releasing and/or scent absorbing-releasing form to distribute the scent in water.

2. The scent releasing and/or scent absorbing-releasing system of claim 1, further comprising means to enable easy placement and/or removal of said scent releasing and/or scent absorbing-releasing form in/from the holding compartment.

3. The scent releasing and/or scent absorbing-releasing system of claim 1, in which said scent releasing and/or scent absorbing-releasing form is constituted as flakes, particles, or formed or pellet-shaped chum.

4. The scent releasing and/or scent absorbing-releasing system of claim 1, in which said scent releasing and/or scent absorbing-releasing form is composed of a material that is operable to readily absorb applied scent in air and release the scent in water.

5. The scent releasing and/or scent absorbing-releasing system of claim 1, in which said scent releasing and/or scent absorbing-releasing form comprises means for creating a longer lasting fish-attracting scent release and/or an initial rapid scent release, combined with a longer lasting fish-attracting scent release.

6. The scent releasing and/or scent absorbing-releasing system of claim 1, in which said scent releasing, and/or scent absorbing-releasing form is shaped in a single cylindrical, cube, rectangular, oblong, or spherical form.

7. The scent releasing and/or scent absorbing-releasing system of claim 1, in which said scent releasing and/or scent absorbing-releasing form is comprised of a plurality of scent releasing and/or scent absorbing-releasing forms that are joined together as one piece.

8. The scent releasing and/or scent absorbing-releasing system of claim 7, in which said plurality of scent releasing and/or scent absorbing-releasing forms that are joined together with an adhesive or thread.

9. The scent releasing and/or scent absorbing-releasing system of claim 1, in which said scent releasing and/or scent absorbing-releasing form is a capsule containing chum or scent material, wherein the outer shell of the capsule is made of a material that dissolves in water at a certain rate, thereby releasing the fishing chum or fish-attracting scent material into the water as the capsules dissolves.

10. The scent releasing and/or scent absorbing-releasing system of claim 1, in which said scent releasing and/or scent absorbing-releasing form comprises means for absorbing and releasing a scent producing material.

11. A method for scent releasing and/or scent absorbing-releasing, in combination with an inline, rotating fishing chum or fish scent dispenser, the method comprising:
Steps for absorbing and releasing a scent producing material, said scent releasing and/or scent absorbing-releasing form being suitable to be placed inside a holding compartment of the in-line, rotating fishing chum and/or fishing scent dispenser; and
Steps for releasing the scent stored in said scent releasing and/or scent absorbing-releasing form to distribute the scent in water.

12. The scent releasing and/or scent absorbing-releasing method of claim 11, further comprising steps to join a plurality of scent releasing and/or scent absorbing-releasing forms together as one piece.

13. A composition for scent releasing and/or scent absorbing-releasing, in combination with an in-line, rotating fishing chum and/or fishing scent dispenser, the composition comprising:
a scent releasing and/or scent absorbing-releasing material that is operable for releasing and/or absorbing-releasing a scent producing material, said scent releasing and/or scent absorbing-releasing material being suitable to be placed inside a holding compartment of the inline, rotating fishing chum and/or fishing scent dispenser; and
means for releasing the scent stored in said scent releasing and/or scent absorbing-releasing material to distribute the scent in water.

14. The scent releasing and/or scent absorbing-releasing composition of claim 13, in which the scent producing material is a fish-attracting oil or a liquid fish-attracting scent.

15. The scent releasing and/or scent absorbing-releasing composition of claim 13, in which said scent releasing and/or scent absorbing-releasing material is constituted as flakes, particles, or formed or pellet-shaped chum.

16. The scent releasing and/or scent absorbing-releasing composition of claim 13, in which said scent releasing and/or scent absorbing-releasing material is composed of a material is that operable to readily absorb applied scent in air and release the scent in water.

17. The scent releasing and/or scent absorbing-releasing composition of claim 13, in which said scent releasing and/or scent absorbing-releasing material comprises means for creating a longer lasting fish-attracting scent release.

18. The scent releasing and/or scent absorbing-releasing composition of claim 13, in which said scent releasing and/or scent absorbing-releasing material is shaped in a single cylindrical or spherical form.

19. The scent releasing and/or scent absorbing-releasing composition of claim 13, in which said scent releasing and/or scent absorbing-releasing material is made of foam, wool, felt, plastic, cloth, scent materials, scent-impregnated paper products, gelatinous forms, or cotton.

20. The scent releasing and/or scent absorbing-releasing composition of claim 13, in which said scent releasing and/or scent absorbing-releasing material comprises salmon eggs, corn, solid chum or scent material, meat or meat products, or a scent releasing bait.

21. The scent releasing and/or scent absorbing-releasing composition of claim 13, in which said scent releasing and/or scent absorbing-releasing material is comprised of a plurality of scent releasing and/or scent absorbing-releasing materials that are joined together as one piece.

22. The scent releasing and/or scent absorbing-releasing composition of claim 13, in which said plurality of scent releasing and/or scent absorbing-releasing materials that are joined together with an adhesive or thread.

23. The scent releasing and/or scent absorbing-releasing composition of claim 13, in which said scent releasing and/or scent absorbing-releasing material is a capsule containing chum or scent material, wherein the outer shell of the capsule is made of a material that dissolves in water at a certain rate, thereby releasing the chum or scent material into the water as the capsules dissolves.

24. The scent releasing and/or scent absorbing-releasing composition of claim 13, in which said scent releasing and/or scent absorbing-releasing material comprises means for releasing and/or absorbing-releasing a scent producing material.
